(19) United States
(12) Patent Application Publication
(10) Pub. No.: US 2004/0264926 A1
(43) Pub. Date: Dec. 30, 2004

(54) Video receiver and video receiving system

(75) Inventors: Yoshinori Mizushima, Takefu-shi (JP); Tetsuo Tsurusaki, Takefu-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 10/872,489

(22) Filed: Jun. 22, 2004

(30) Foreign Application Priority Data
Jun. 27, 2003 (JP) 2003-185391

(51) Int. Cl. H04N 5/783

(52) U.S. Cl. 386/69; 386/70

(57) ABSTRACT

This invention provides a video receiver which displays a thumbnail index image which shows an outline of recorded contents in a recording medium to be reproduced by reproducing means connected to the video receiver when the video receiver is turned on. The video receiver, which includes a television monitor and to which the reproducing means is connected, is constituted as follows. When the video receiver is turned on, a recording medium thumbnail index image is read from the recording medium of the reproducing means, and this recording medium thumbnail index image is displayed on the television monitor.

### BACKGROUND OF THE INVENTION

1. Field of the Invention

The present invention relates to a video receiver and a video receiving system.

2. Description of the Related Art

A video receiver receives a broadcast channel transmitted from a broadcast station, and outputs a video or a voice based on a broadcast signal on the received channel to a television monitor (hereinafter, “TV monitor”). A user who uses the video receiver can thereby view and listen to a broadcast program broadcasted by the broadcast station.

The video receiver often controls reproducing means such as a digital versatile disk (DVD) player or a videotape recorder (VTR) connected to the receiver, to reproduce data from a recording medium such as a DVD disk or a videotape, and to output the reproduced data to the TV monitor.

An image reproducing apparatus which reproduces the data from the recording medium and which displays the reproduced data is often constituted to display a thumbnail index image which is a list of recorded contents in the recording medium (see, for example, Japanese Patent Application Laid-Open No. 2001-211407).

This thumbnail index image enables a user of the image reproducing apparatus to grasp an overall outline of the recorded contents in the recording medium. The user can select and reproduce a content, which the user wants to view and listen to from those in the recording medium based on the display of the thumbnail index image.

Meanwhile, the conventional video receiver or image reproducing apparatus is incapable of displaying the thumbnail index image of the recording medium right after the receiver or the apparatus is turned on.

In order to display this thumbnail index image, it is required to perform a fixed operation after starting an operation of the video receiver or the image reproducing apparatus. Therefore, it requires complicated operation before the user grasps the outline of the recorded contents in the recording medium and selects the desired content.

### SUMMARY OF THE INVENTION

It is, therefore, an object of the present invention to provide a video receiver and a video receiving system which can easily display a thumbnail index image which shows an outline of recorded contents in a recording medium without being required to perform complicated operation.

According to a first aspect of the present invention, there is provided a video receiver comprising a TV monitor for receiving one of broadcast channels transmitted from a broadcast station, and for outputting a broadcast content on the received broadcast channel, wherein

reproducing means, connected to the video receiver, for reproducing each of recorded contents in a recording medium is controlled to output the recorded content reproduced by the reproducing means to the TV monitor,

a recording medium thumbnail index image which shows indexes of the recorded contents in the recording medium is recorded in the recording medium,

the video receiver comprises a control section which controls an operation of the video receiver, and

when the video receiver is turned on, the control section controls the reproducing means to read the recording medium thumbnail index image from the recording medium, and to output the recording medium thumbnail index image to the TV monitor.

According to the first aspect of the present invention, when the video receiver is turned on, the recording medium thumbnail index image is displayed on the TV monitor. This can facilitate easy-checking the outline of recorded contents in the recording medium reproduced by the reproducing means connected to the video receiver.

According to a second aspect of the present invention, the video receiver according to the first aspect of the present invention can be constituted so that:

the video receiver further comprises a broadcast channel index image storage section which stores a broadcast channel index image showing indexes of the broadcast channels which can be received by the video receiver,

the broadcast channels to be received are sequentially set to a tuner for receiving the broadcast channels, one image in the broadcast content on each of the received broadcast channels is sequentially stored for the each received broadcast channel in the broadcast channel index image storage section, and the broadcast channel index image is formed,

the video receiver further comprises an image forming section which forms an image output to the TV monitor,

the image forming section forms a compound index image from the recording medium thumbnail index image and the broadcast channel index image, and so that

when the video receiver is turned on, the compound index image is output to the TV monitor.

According to the second aspect of the present invention, when the video receiver is turned on, the compound index image is displayed on the TV monitor. This can facilitate easy-checking the outline of the broadcast channels, which can be viewed and listened to by the video receiver, and the outline of the recorded contents in the recording medium reproduced by the reproducing means connected to the video receiver.

According to a third aspect of the present invention, the video receiver according to the second aspect of the present invention can be constituted so that:

the video receiver further comprises a screen dividing section which performs a processing for dividing the image displayed entirely on one screen of the TV monitor into a plurality of parts, and for displaying the divided parts,

the screen dividing section divides the compound index image into the recording medium thumbnail index image and the broadcast channel index image, and so that

the recording medium thumbnail index image is displayed in a first region on the one screen of the TV monitor, and the broadcast channel index image is displayed in a second region on the one screen of the TV monitor.

According to the third aspect of the present invention, the video receiver divides the compound index image into the recording medium thumbnail index image and the broadcast channel index image, and displays the recording medium thumbnail index image and the broadcast channel index image on one screen of the TV monitor. This can facilitate easy-checking the outline of the broadcast channels and that of the recorded contents in the recording medium reproduced by the reproducing means while discriminating them from each other.

According to a fourth aspect of the present invention, the video receiver according to the first aspect of the present invention can be constituted so that:

a plurality of the reproducing means are connected, and the recording medium thumbnail index image is recorded in each recording medium reproduced by each of the reproducing means,

the video receiver further comprises an image forming section which forms an image output to the TV monitor,

a plurality of the recording medium thumbnail index images are read from the plurality of the recording mediums, respectively, and the image forming section combines the read plurality of recording medium thumbnail index images into a recording medium combined index image composed of one image, and so that

when the video receiver is turned on, the recording medium combined index image is displayed on the TV monitor.

According to the fourth aspect of the present invention, when the video receiver is turned on, the recording medium combined index image can be displayed on the TV monitor. This can facilitate easy-checking recorded contents in the respective recording mediums reproduced by a plurality of reproducing means.

According to a fifth aspect of the present invention, the video receiver according to any one of the first to fourth aspects of the present invention can be constituted so that reproducing means disposed in a main body of the video receiver can be provided as the reproducing means.

According to a sixth aspect of the present invention, the video receiver according to any one of the first to fifth aspect of the present invention can be constituted so that a reproducing apparatus disposed as an external apparatus other than the video receiver can be connected to the video receiver as the reproducing means. According to a seventh aspect of the present invention, a video receiving system can be constituted by the reproducing apparatus disposed as the external apparatus other than the video receiver and the video receiver according to the sixth aspect of the present invention.

### BRIEF DESCRIPTION OF THE DRAWINGS

FIG. 1 illustrates a video receiver according to one embodiment of the present invention;

FIG. 2 is a block diagram of the video receiver according to the invention;

FIG. 3 illustrates connection between the video receiver and an HDD recording and reproducing apparatus according to the invention;

FIGS. 4A to 4C illustrate examples of an operation menu displayed on a TV monitor according to the invention;

FIG. 5 illustrates one example of a compound index image displayed on the TV monitor according to the invention;

FIG. 6 is a flowchart, which illustrates one example of procedures for causing the video receiver to operate according to the invention;

FIG. 7 illustrates one example of images displayed on the TV monitor by screen division display according to the invention;

FIG. 8 illustrates one example of a compound index image displayed on the TV monitor according to the invention;

FIGS. 9A to 9C illustrate one example of the operation menu displayed on the TV monitor according to the invention;

FIG. 10 is a flowchart, which shows one example of procedures for causing the video receiver to operate according to the invention;

FIG. 11 illustrates one example of images displayed on the TV monitor by screen division display according to the invention; and

FIGS. 12A and 12B illustrate examples of the display of the TV monitor in relation to execution of a dubbing mode according to the invention.

### DESCRIPTION OF THE PREFERRED EMBODIMENT

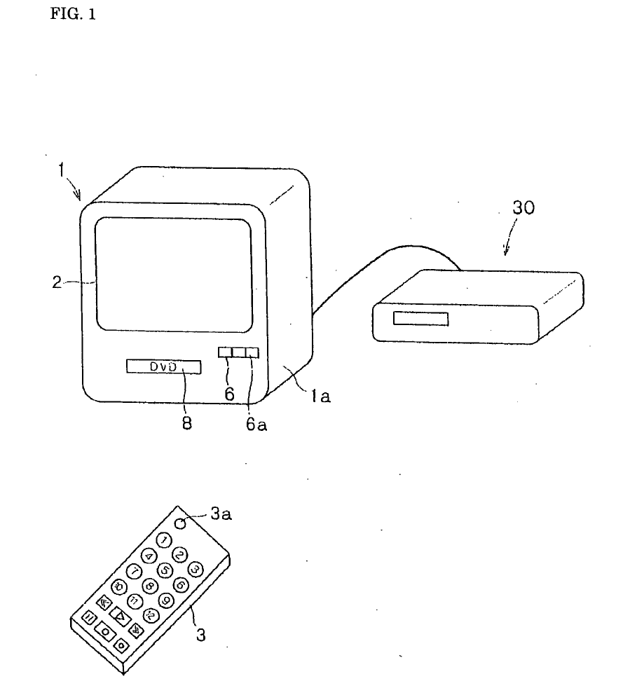

An embodiment of the present invention will be described hereinafter with reference to FIGS. 1 to 12. FIG. 1 illustrates a video receiver 1 according to one embodiment of the present invention. FIG. 1 also illustrates a video receiving system composed of the video receiver 1 and a hard disk drive (HDD) recording and reproducing apparatus 30.

The video receiver 1 shown in FIG. 1 has a TV monitor 2 incorporated in a main body la of the receiver 1. A user who uses the video receiver 1 can view and listen to a broadcast content on a received broadcast channel, a recorded file recorded in each disk reproduced by a DVD recording and reproducing means 20, to be described later, or the HDD recording and reproducing apparatus 30, or the like through this TV monitor 2.

A DVD disk insertion section 8 is provided in a front portion of the main body la of the video receiver 1. A DVD disk can be inserted into the DVD recording and reproducing means 20 provided in the main body la, and taken out from the DVD recording and reproducing means 20 through this DVD disk insertion section 8.

An operation panel 6 is provided in the front portion of the main body 1a of the video receiver 1. The operation panel 6 is provided with a main power switch 6a for turning on and off the video receiver 1. By turning on this main power switch 6a, a power can be supplied to the video receiver 1. By turning off the main power switch 6a, supply of the power to the video receiver 1 can be stopped.

The video receiver 1 can be operated by an operation remote controller 3. The operation remote controller 3 is provided with various operation keys for operating the video receiver 1. The operation remote controller 3 includes a power key 3a as one of the operation keys.

If the user turns off the power key 3a while turning on the main power switch 6a, the video receiver 1 stops operating. If the user turns on the power key 3a while the operation of this video receiver 1 is stopped, the video receiver 1 starts operating.

The operation remote controller 3 also includes various operation keys necessary to operate the video receiver 1 such as an operation menu display key, a channel select key, and a recording and reproducing key.

The operation menu display key is an operation key for outputting various operation menus used to set conditions for causing the video receiver 1 to operate, to a TV screen of the TV monitor 2.

The channel select key is an operation key used when the user selects a broadcast channel, which the user wants to view and listen to. When the user selects a broadcast channel by the channel select key, a received frequency of the selected broadcast channel is set to a tuner 5, and the user can view and listen to a broadcast content on the selected broadcast channel by means of the TV monitor 2.

The recording and reproducing key is an operation key for causing the DVD recording and reproducing means 20 or the HDD recording and reproducing apparatus 30 to operate.

When working this video receiver 1, the operation remote controller 3 may be provided with a specific display-dedicated key for displaying abroad cast channel index image or a recording medium thumbnail index image, both to be described later, on the TV monitor 2.

When this specific display-dedicated key is operated, the broadcast channel index image or the recording medium thumbnail index image can be displayed on the TV monitor 2 after turning on the video receiver 1.

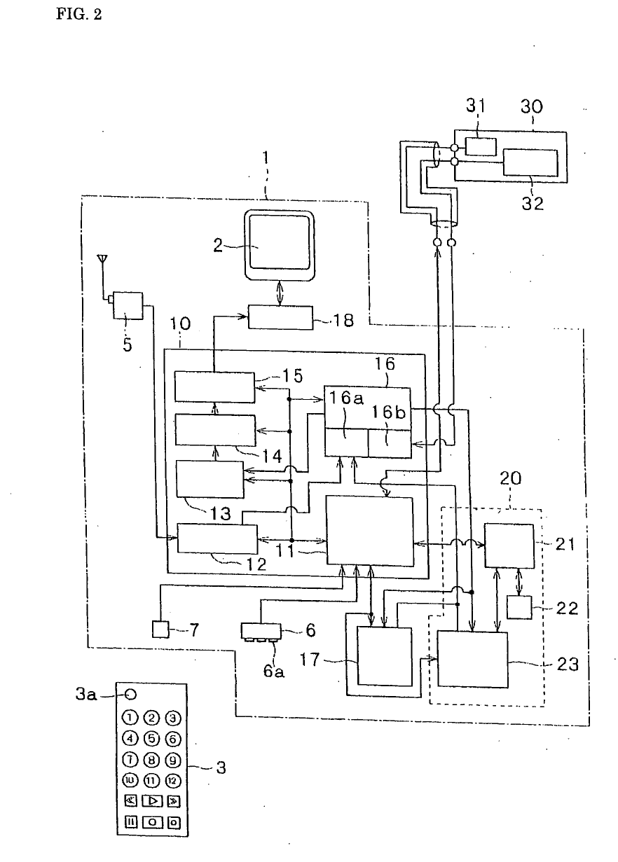

Constituent blocks of the video receiver 1 will next be described with reference to FIG. 2. FIG. 2 is a block diagram, which illustrates a state in which the HDD recording and reproducing apparatus 30 is connected to the video receiver 1. As shown in FIG. 2, the video receiver 1 includes a tuner 5, a main microcomputer 10, an external memory 17, the DVD recording and reproducing means 20, the operation panel 6, a remote controller light receiving section 7, a display processing section 18, and the TV monitor 2.

An antenna is connected to the tuner 5. The tuner 5 selects and receives a broadcast wave on a broadcast channel to be received. The broadcast channel to be received (or a specific frequency allocated to the broadcast channel) is set to the tuner 5 by a channel select processing section 12 to be described later.

When the tuner 5 receives the set broadcast channel, a broadcast signal (both of or one of a video signal and a voice signal) on this broadcast channel is output from the tuner 5 to the channel select processing section 12.

The main microcomputer 10 controls entirety of the video receiver 1. The main microcomputer 10 includes a central processing unit (CPU), a read only memory (ROM), and a random access memory (RAM).

The external memory 17 is connected to the main microcomputer 10. The external memory 17 is constituted so that the main microcomputer 10 can read and write data from and to the external memory 17. This external memory 17 can be composed of an E2PROM.

In the main microcomputer 10, a control section 11, the channel select processing section 12, an extraction section 16, an image forming section 13, a screen dividing section 14 and a display control section 15 are provided. The respective sections provided in the main microcomputer 10 are modularized by a program subjected to an operation processing provided in the ROM.

The control section 11 controls an operation of the main microcomputer 10. By controlling the respective sections of the main microcomputer 10, the main microcomputer 10 controls an operation of the video receiver 1.

The channel select processing section 12 sets (a specific frequency of) a broadcast channel to be received by the tuner 5. Data on the received frequency of the broadcast channel to be received is input to the channel select processing section 12 from the control section 11.

The control section 11 reads the data on the received frequency of the broadcast channel to be received from the external memory 17. The external memory 17 stores pieces of data on received frequencies of broadcast channels, which can be received by the video receiver 1. The broadcast channels which can be received by the video receiver 1 and the pieces of data on the received frequencies of the broadcast channels are stored in the external memory 17 in advance by automatic broadcast channel presetting.

If the video receiver 1 is set into a mode for forming a broadcast channel index image to be described later, then the control section 11 sequentially reads the pieces of data on the received frequencies of the respective broadcast channels from the external memory 17, and inputs the read data to the channel select processing section 12.

When the broadcast channel to be received is set to the tuner 5, and the tuner 5 receives the broadcast signal (video signal and/or the voice signal) on this broadcast channel, the broadcast signal received by the tuner 5 is input to the channel select processing section 12 from the tuner. The video signal that is input to the channel select processing section 12 is processed as follows.

If the video receiver 1 is set into a TV mode for receiving a specific broadcast channel and outputting a broadcast content to the TV monitor 2, the video signal input to the channel select processing section 12 is input to an internal video input section 16a of the extraction section 16 to be described later.

If the video receiver 1 is set into the mode for forming the broadcast channel index image, then the video signal input to the channel select processing section 12 is input to the control section 11, and is input to a broadcast channel index image storage section, not shown, from the control section 11.

The broadcast channel index image storage section forms the broadcast channel index image based on the video signal input from the control section 11. This broadcast channel index image is composed of index videos corresponding to indexes of the broadcast channels which can be received. The broadcast channel index image is, therefore, composed of a plurality of frames in each of which one broadcast channel index video is displayed.

In forming this broadcast channel index image, the broadcast channel index image can be constituted by a thumbnail index image.

The broadcast channel index image storage section, which forms the broadcast channel index image, is provided in the external memory 17. Alternatively, this broadcast channel index image storage section can be provided in the RAM of the main microcomputer 10.

The extraction section 16 performs a processing for switching a signal source of the video signal when the video is output to the TV monitor 2. The extraction section 16 includes the internal video input section 16a and an external video input section 16b.

The internal video input section 16a is input the video signal on the received broadcast channel while the video receiver 1 is in the TV mode, from the channel select processing section 12. The internal video input section 16a is also input the video signal reproduced and output from the DVD disk by the DVD recording and reproducing means 20. The external video input section 16b is input the video signal reproduced and output from a hard disk (HD) by the HDD recording and reproducing apparatus 30.

The internal video input section 16a and the external video input section 16b are controlled by the control section 11 so that each of the input sections 16a and 16b is turned into a state in which the input section can input the video signal or a state in which the input section cannot input the video signal. The control section 11 controls the internal video input section 16a and the external video input section 16b in accordance with operation states of the DVD recording and reproducing means 20 and the HDD recording and reproducing apparatus 30, and with the operation mode of the video receiver 1. The video signal that is input to the extraction section 16 is output to the image forming section 13.

The image forming section 13 performs a processing for forming an image to be output to the TV monitor 2. Namely, the image forming section 13 performs a processing for forming an image to be displayed on one screen of the TV monitor 2 based on the input video signal.

The image forming section 13 is input the video signal from the extraction section 16. The image forming section 13 is also input an internal recording medium thumbnail index image output from the DVD recording and reproducing means 20, to be described later, and an external recording medium thumbnail index image output from the HDD recording and reproducing apparatus 30, to be described later.

The image forming section 13 forms a compound index image obtained by combining the broadcast channel index image with the recording medium thumbnail index image into one image. In forming the compound index image, the internal recording medium thumbnail index image or external recording medium thumbnail index image is combined with the broadcast index image.

The image forming section 13 also forms a recording medium combined index image obtained by combining the internal recording medium thumbnail index image with the external recording medium thumbnail index image into one image.

A processing for reducing or enlarging the video based on the video signal so as to form the image to be displayed on one plane of the TV screen of the TV monitor 2 is performed by this image forming section 13.

A processing for reducing or enlarging the broadcast channel index image, the internal recording medium thumbnail index image, and the external recording medium thumbnail index image is also performed by the image forming section 13. In addition, a processing for reducing element images in the formation of the compound index image and the recording medium combined index image is performed by the image forming section 13.

The image forming section 13 forms the compound index image or the recording medium combined index image so that the broadcast channel index image and the like to serve as the elements of the compound index image or the recording medium combined index image can be arranged on the screen of the TV monitor 2 under conditions set by a screen division display item on the operation menu to be described later.

The (video signal corresponding to) image formed by the image forming section 13 is input to the screen dividing section 14. The screen dividing section 14 performs a processing for dividing the image displayed on the TV screen of the TV monitor 2 into a plurality of parts. Namely, the screen dividing section 14 divides the image formed to correspond to one screen of the TV monitor 2 by the image forming section 13 into a plurality of parts.

The screen dividing section 14 divides the input image into a plurality of parts in accordance with screen dividing conditions. The screen dividing conditions are set according to conditions set by the screen division display item on the operation menu to be described later.

If the image formed by the image forming section 13 is not divided into a plurality of parts when outputting the image to the TV monitor 2, the image input to the screen dividing section 14 is output to the display control section 15 without being divided into a plurality of parts.

The display control section 15 performs a processing for adjusting a magnitude of the (video signal corresponding to) input image to display the image on the TV monitor 2. For example, if the screen division display is performed, the display control section 15 adjusts the magnitude of one half of the divided image to two-thirds of the magnitude of the screen of the TV monitor 2, and adjusts the magnitude of the other half to one-third thereof.

The video signal processed by the-display control section 15 is output to the display processing section 18 to be described later.

The control section 11 of the main microcomputer 10 is input an operation button identification signal corresponding to an ON or OFF state of each operation button provided on the operation panel 6. The control section 11 then detects the ON or OFF state of the operation button based on the operation button identification signal, and exercises a control corresponding to the detected state. When the power button 6a is turned on, the main microcomputer 10 executes a starting program to thereby start the operation of the video receiver 1.

The control section 11 of the main microcomputer 10 is also input an operation key identification signal for identifying each operation key on the operation remote controller 3 from the remote controller light receiving section 7. When the user operates one of the operation keys on the operation remote controller 3, the operation key identification signal allocated to each operation key is output from the operation remote controller 3 and input to the remote controller light receiving section 7.

The control section 11 of the main microcomputer 10 detects a type of the operated operation key and the ON or OFF state of the key based on the operation key identification signal input from the remote controller light receiving section 7.

The ROM of the main microcomputer 10 stores an input operation control program for displaying various operation menus on the TV screen of the TV monitor 2, and for reading a content input by a user's operation based on the displayed operation menu. The ROM of the main microcomputer 10 also stores various control programs necessary to control the operation of the video receiver 1.

The display processing section 18 performs a processing for outputting the input video signal to the TV monitor 2 as a video. The display processing section 18 includes a color signal processing circuit including a chroma IC and a deflection circuit. This display processing section 18 processes a horizontal scan, a vertical scan, a luminance, a color control, or the like based on the input video signal so as to display the video on the TV monitor 2.

The display processing section 18 is input the video signal from the display control section 15. The video signal input to the display processing section 18 is processed by the display processing section 18, and output to the TV monitor 2.

The DVD recording and reproducing means 20 reproduces a recording content of a recorded file or the like recorded in the DVD disk 23 when the means 20 is set into a reproducing mode. When being set into a recording mode, the DVD recording and reproducing means 20 records both of or one of the video and the voice in the DVD disk 23 and edits the recorded file on the DVD disk 23.

In the DVD disk 23, a plurality of recorded files is managed with fixed titles individually given thereto. The DVD disk 23 records the internal recording medium thumbnail index image composed of a set of index images of the respective recorded files.

The DVD recording and reproducing means 20 includes a DVD microcomputer 21 and an external memory 22. The DVD microcomputer 21 controls an operation of the DVD recording and reproducing means 20.

The DVD microcomputer 21 includes a CPU, a ROM, and a RAM, which are not shown. The ROM of the DVD microcomputer 21 stores a control program for controlling the operation of the DVD recording and reproducing means 20.

The DVD microcomputer 21 is controlled by the main microcomputer 10. Conditions for causing the DVD recording and reproducing means 20 to operate can be set by displaying a DVD operation menu on the TV monitor 2, and inputting data based on the DVD operation menu. The input of the data based on the DVD operation menu is performed by operating the operation remote controller 3.

When being set into a reproducing mode, the HDD recording and reproducing apparatus 30 reproduces a recording content of a recorded file or the like recorded in the hard disk (HD) 32. When being set into a recording mode, the HDD recording and reproducing apparatus 30 records both of or one of the video and the voice in the HD 32, and edits the recorded file on the HD 32.

In the HD 32, a plurality of recorded files is managed with fixed titles individually given thereto. The HD 32 records the external recording medium thumbnail index image composed of a set of index images of the respective recorded files.

The HDD recording and reproducing apparatus 30 includes an HDD microcomputer 31 and an external memory, which is not shown in FIG. 2. The HDD microcomputer 31 controls an operation of the HDD recording and reproducing apparatus 30.

The HDD microcomputer 31 includes a CPU, a ROM, and a RAM, which are not shown in FIG. 2. The ROM of the HDD microcomputer 31 stores a control program for controlling the operation of the HDD recording and reproducing apparatus 30.

The HDD microcomputer 31 is controlled by the main microcomputer 10 of the video receiver 1. Conditions for causing the HDD recording and reproducing apparatus 30 to operate can be set by displaying an HDD operation menu on the TV monitor 2, and inputting data based on the HDD operation menu. The input of the data based on the HDD operation menu is performed by operating the operation remote controller 3.

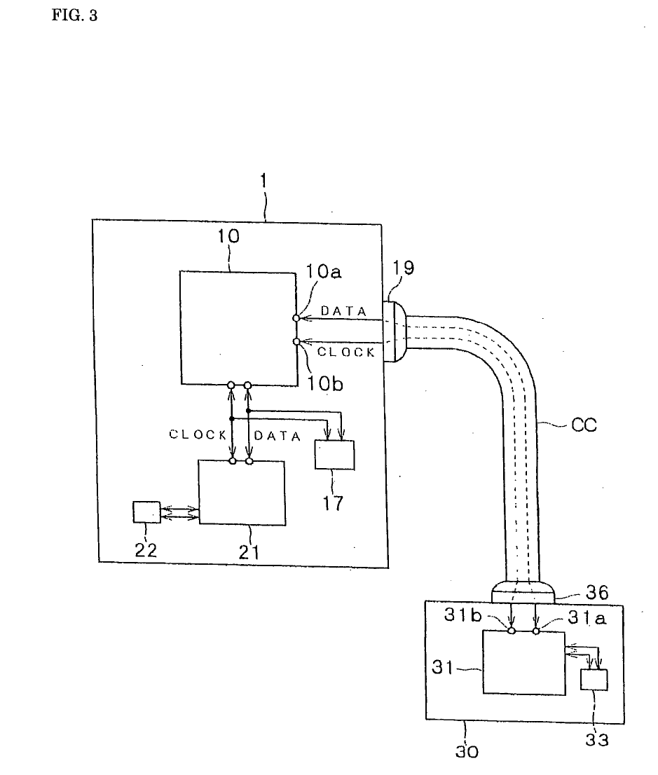

One example of a method for connecting the HDD recording and reproducing apparatus 30 to the video receiver 1, and one example of a method for holding communication between the HDD recording and reproducing apparatus 30 and the video receiver 1 will be described with reference to FIG. 3.

In FIG. 3, reference numeral 10a denotes a data terminal of the main microcomputer 10 and 10b denotes a clock terminal of the main microcomputer 10. Reference numeral 31a denotes a data terminal of the HDD microcomputer 31 and 31b denotes a clock terminal of the HDD microcomputer 31. Reference numeral 33 denotes an external memory connected to the HDD microcomputer 31 of the HDD recording and reproducing apparatus 30.

An external connection terminal 19 is provided at the video receiver 1. An external connection terminal 36 is provided at the HDD recording and reproducing apparatus 30. A communication cable CC is connected between the external connection terminal 19 of the video receiver 1 and the external connection terminal 36 of the HDD recording and reproducing apparatus 30.

The data terminal 10a of the main microcomputer 10 is connected to the data terminal 31a of the HDD microcomputer 31 through a data pin of the external connection terminal 19, a data line within the communication cable CC, and a data pin of the external connection terminal 36.

The clock terminal 10b of the main microcomputer 10 is connected to the clock terminal 31b of the HDD microcomputer 31 through a clock pin of the external connection terminal 19, a clock line within the communication cable CC, and a clock pin of the external connection terminal 36.

The main microcomputer 10 and the HDD microcomputer 31 transmit and receive data to and from each other through the data terminal 10a and clock terminal 10b of the main microcomputer 10, and the data terminal 31a and clock terminal 31b of the HDD microcomputer 31. By transmitting and receiving data to and from each other, the main microcomputer 10 and the HDD microcomputer 31 can control each other. A serial communication means is employed to transmit and receive the data between the main microcomputer 10 and the HDD microcomputer 31.

In connecting the video receiver 1 to the HDD recording and reproducing apparatus 30, a communication means in conformity to Home Audio Video Interoperability (HAVi) which is one of standards according to Institute of Electrical and Electronics Engineers (IEEE) 1394, can be provided.

Further, in transmitting and receiving the data between the video receiver 1 and the HDD recording and reproducing apparatus 30, the data can be transmitted not only as an electric signal therebetween through the communication cable CC but also by optical communication using an optical fiber. In addition, in transmitting and receiving the data between the video receiver 1 and the HDD recording and reproducing apparatus 30, the data can be transmitted therebetween by wireless communication using an infrared ray.

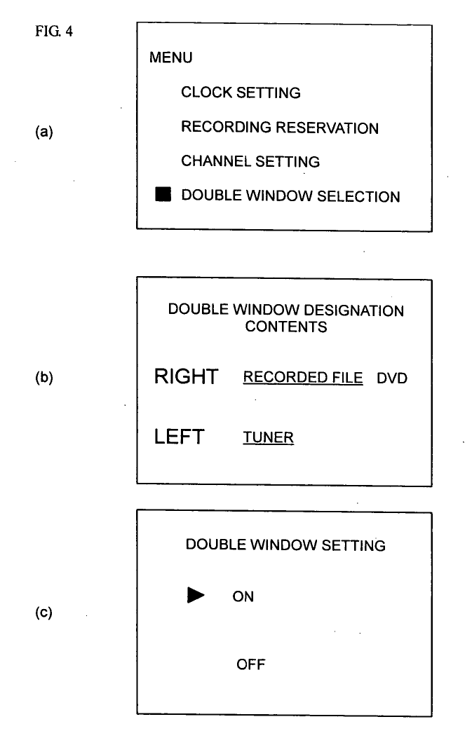

Examples of the operation menu for setting the conditions for causing the video receiver 1 to operate will be described with reference to FIGS. 4A to 4C. FIGS. 4A to 4C illustrate examples of the operation menu displayed on the TV screen of the TV monitor 2.

In FIG. 4A, “clock setting”, “recording reservation”, “channel setting, and “double window selection” are displayed as items for input operation based on the display of the operation menu.

Among the items shown in FIG. 4A, the “double window selection” item is one example of the screen division display item for dividing one image displayed on one screen of the TV monitor 2 into a plurality of parts and for displaying the divided images. According to this “double window selection” item, conditions for dividing the compound index image or the recording medium combined index image into two parts, and displaying the two parts on one screen of the TV monitor 2 can be set, when the video receiver 1 is turned on.

Based on the operation menu shown in FIG. 4A, the “double window selection” item is selected. As a result, as shown in FIG. 4B, the conditions for dividing the image into two parts and for displaying the two parts on the TV monitor 2 are shown. FIG. 4B illustrates one example of the conditions for dividing the compound index image into two parts, and for displaying the two parts on the TV monitor 2.

FIG. 4B indicates designation contents for displaying the images by “double windows”. Namely, the internal recording medium thumbnail index image which shows a list of the recorded files stored in the DVD disk 23 is displayed on a right side of one screen of the TV monitor 2. The broadcast channel index image which shows a list of broadcast channels received by the tuner 5 is displayed on a left side of one screen of the TV monitor 2.

If the screen division display conditions are set according to the display of the operation menu shown in FIG. 4B, the operation menu for turning on or off the “double window setting” item based on the input conditions is displayed as shown in FIG. 4C.

FIG. 4C illustrates one example of turning on the “double window setting” item. If the “double window setting” item is turned on, the screen division display is performed based on the conditions input by the operation menu shown in FIG. 4B when the video receiver 1 is turned on.

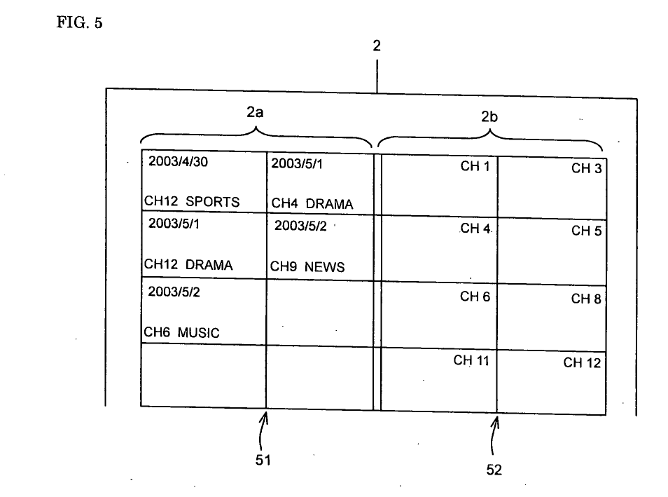

FIG. 5 illustrates one example of the screen division display appearing on the TV monitor 2. As shown in FIG. 5, the compound index image is divided into an internal recording medium thumbnail index image 51 and a broadcast channel index image 52, and the index images 51 and 52 are displayed on the TV screen of the TV monitor 2.

The internal recording medium thumbnail index image 51 is displayed in a first region 2a which corresponds to the right side of the screen of the TV monitor 2 (the right side relative to a TV side). The broadcast channel index image 52 is displayed in a second region 2b which corresponds to the left side of the screen of the TV monitor 2 (the left side relative to the TV side).

In the example shown in FIG. 5, the internal recording medium thumbnail index image 51 is composed of eight frames. Each frame is formed by an index image, which shows a recording content, recorded in the DVD disk 23.

In an uppermost frame on a right end of the internal recording medium thumbnail index image 51, for example, the index image which represents recording of a sports program broadcast on TV broadcast Channel 12 on Apr. 30, 2003 is shown.

In the example shown in FIG. 5, the broadcast channel index image 52 is composed of eight frames. Each frame is formed by an index image, which shows a broadcast channel, which can be received by the video receiver 1. In an uppermost frame on a left end of the broadcast channel index image 52, for example, the index image that represents TV broadcast Channel 3 is shown.

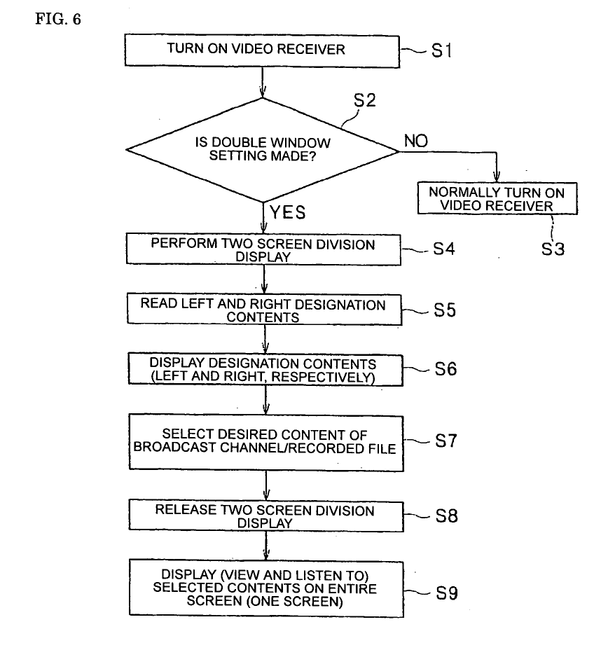

An example of the operation of the video receiver 1 will be described with reference to FIG. 6. FIG. 6 is a flowchart, which shows procedures for the operation of the video receiver 1. Specifically, FIG. 6 illustrates the procedures for displaying the compound index image on the TV monitor 2, and for causing the video receiver 1 to operate so that the user can view and listen to a specific recording content on a specific broadcast channel or in the recording medium.

When the video receiver 1 is turned on (in a step S1), it is determined whether a double window setting is made (in a step S2). If the double window setting is not made (“NO” in the step S2), the video receiver 1 is normally turned on (in a step S3).

If the double window setting is made (“YES” in the step S2), a control is started so as to display the compound index image by two screen division display (in a step S4). Designation contents set as the conditions for displaying the images in the left region and the right region of the TV screen on the TV monitor 2, respectively, are read (in a step S5).

The designation contents read in the step S5 are the contents which are set, as the conditions for dividing the compound index image into two parts and displaying the two parts, on the operation menu which makes the double window setting.

Based on the designation contents read in the step S5, the internal recording medium thumbnail index image and the broadcast channel index image are read by the image forming section 13, and combined into the compound index image by the image forming section 13.

In addition, based on the designation contents read in the step S5, the compound index image is divided into the internal recording medium thumbnail index image and the broadcast channel index image by the screen dividing section 14.

Based on the designation contents read in the step S5, the internal recording medium thumbnail index image and the broadcast channel index image are displayed in the left and right regions of the screen on the TV monitor 2, respectively (in a step S6).

Next, based on the internal recording medium thumbnail index image and the broadcast channel index image displayed on the TV monitor 2, the user selects a broadcast channel or a recorded file which the user wants to view and listen to (in a step S7). This selection is made by an operation for selecting and defining a desired frame in the index image displayed on the TV monitor 2.

The two-screen division display of the TV monitor 2 is released (in a step S8). The broadcast channel corresponding to the frame selected in the step S7 is received or the recorded file corresponding to the frame selected in the step S7 is reproduced (in a step S9), and the content of the selected broadcast channel or the content of the selected recorded file is output to the TV monitor 2.

The example in which each of the recording medium thumbnail index image 51 and the broadcast channel index image 52 is composed of a plurality of frames as shown in FIG. 5 has been described. Alternatively, each of the index images may be composed of one frame.

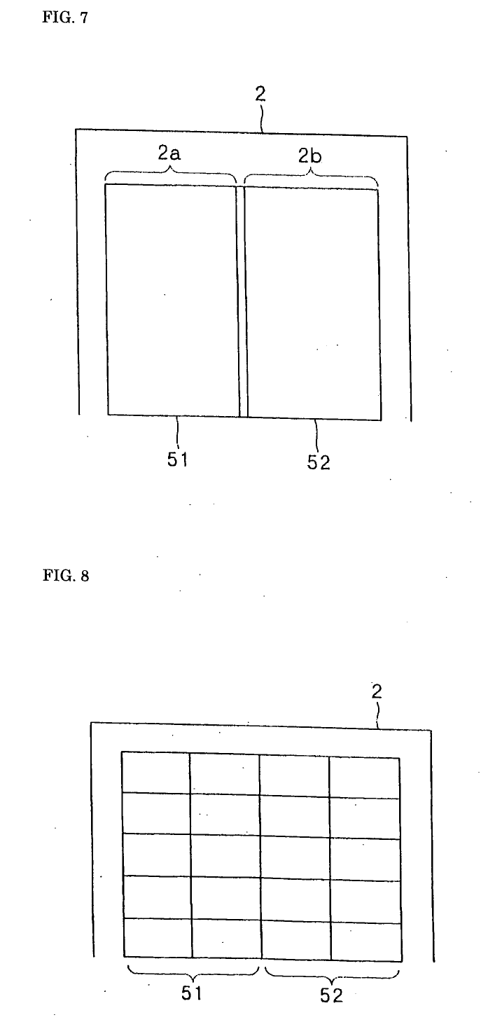

FIG. 7 illustrates one example of displaying the recording medium thumbnail index image 51 and the broadcast channel index image 52 each composed of one frame by the screen division display.

The examples of horizontally dividing the image into the left and right parts on the screen of the TV monitor 2 and displaying the left and right parts on the TV monitor 2 in performing the two screen division display have been described. Alternatively, the image can be displayed by vertically dividing the image into upper and lower parts on the screen of the TV monitor 2.

In FIGS. 5 and 7, the examples of dividing the compound index image into the internal recording medium thumbnail index image 51 and the broadcast channel index image 52, and displaying the index images 51 and 52 have been described. Alternatively, the compound index image can be displayed without dividing it.

FIG. 8 illustrates an example of displaying the compound index image on the TV monitor 2 without dividing it. As shown in FIG. 8, the internal recording medium thumbnail index image 51 and the broadcast channel index image 52 can be displayed on the TV monitor 2 without dividing the compound index image into two parts.

In FIGS. 5, 7, and 8, the examples of displaying the compound index image composed of the internal recording medium thumbnail index image 51 and the broadcast channel index image 52 have been described.

Alternatively, the compound index image displayed on the TV monitor 2 when the video receiver 1 is turned on can be composed of the external recording medium thumbnail index image and the broadcast channel index image.

The examples of displaying the compound index image have been described above. Alternatively, the broadcast channel index image and the internal recording medium thumbnail index image or external recording medium thumbnail index image can be displayed independently on the TV monitor 2.

If the broadcast channel index image and the internal recording medium thumbnail index image or external recording medium thumbnail index image are to be displayed independently, the other index image can be displayed certain time after one index image is displayed. For example, after the video receiver 1 is turned on, the broadcast channel index image can be displayed for predetermined time, and then the internal recording medium thumbnail index image can be displayed the certain time after the broadcast channel index image is displayed.

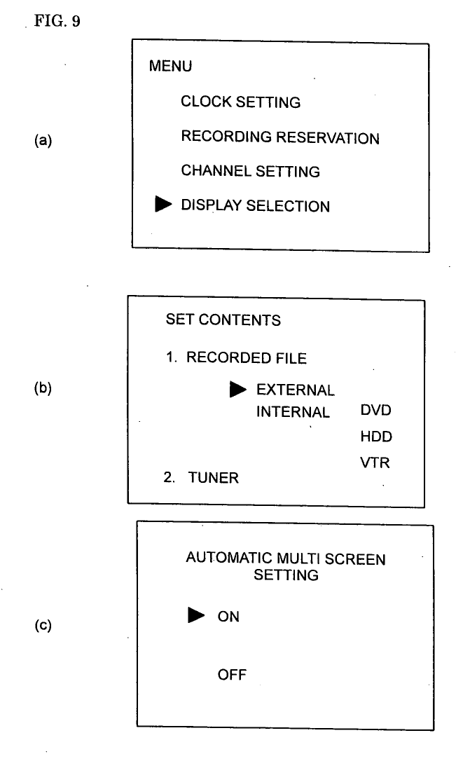

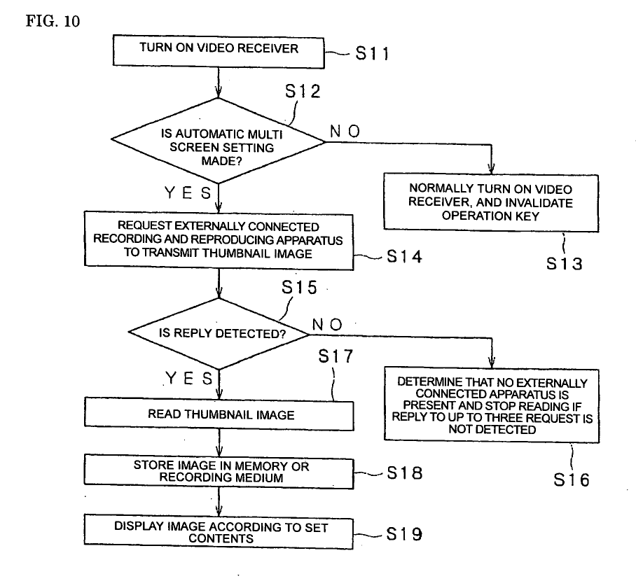

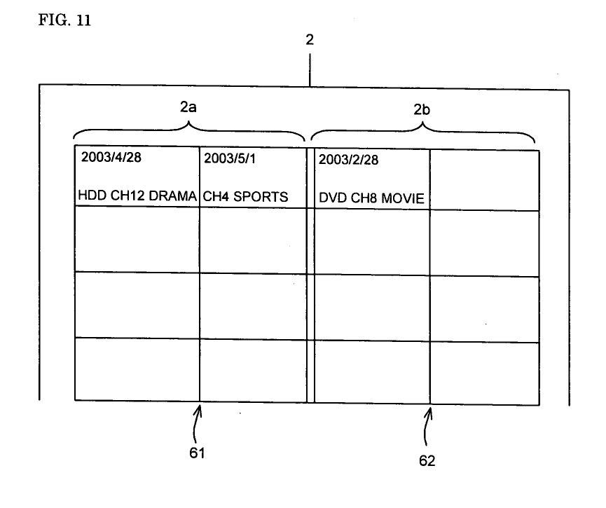

An example of displaying the external recording medium thumbnail index image recorded in the HDD recording and reproducing apparatus 30 will next be described with reference to FIGS. 9A to 9C and FIG. 10. FIGS. 9A to 9C illustrate examples of the operation menu displayed on the TV monitor 2. Specifically, FIGS. 9A to 9C illustrate the operation menu for setting the conditions for displaying the broadcast channel index image and the recording medium thumbnail index image.

In FIG. 9A, “clock setting”, “recording reservation”, “channel setting”, and “display selection” are displayed as items for input operation based on the display of the operation menu. Among the items shown in FIG. 9A, the “display selection” is an item for selecting an image that is displayed on the TV monitor 2 when the video receiver 1 is turned on. According to this “display selection” item, the conditions for displaying the broadcast channel index image and the recording medium thumbnail index image on the TV monitor 2 when the video receiver 1 is turned on can be set.

Based on the display of the operation menu shown in FIG. 9A, the “display selection” item is selected. As a result, as shown in FIG. 9B, a menu for setting the image to be displayed on the TV monitor 2 when the video receiver 1 is turned on is displayed on the TV monitor 2.

In FIG. 9B, the menu including “1. Recorded file” and “2. Tuner” items are displayed so that one of the items can be selected as set contents. In the “1. Recorded file” item, an “External” item is provided.

The “External” item in the “1. Recorded file” item shown in FIG. 9B is an item for selecting the external recording medium thumbnail index image for the recorded files recorded in the HDD recording and reproducing apparatus 30 which is an external apparatus.

Further, the “1. Recorded file” item shown in FIG. 9B also includes an “Internal” item. The “Internal” item in the “1. Recorded file” item is an item for selecting the internal recording medium thumbnail index image for the recorded files recorded in the recording and reproducing means 20 provided within the main body 1a of the vide o receiver 1. In the “Internal” items in the “1. Recorded file”, “DVD”, “HDD”, and “VTR” items are shown.

The “2. Tuner” item shown in FIG. 9B is an item for selecting the broadcast channel index image for the broadcast channels received by the tuner 5.

FIG. 9B illustrates an example of setting the video receiver 1 to the “External” item in “1. Recorded File” item when the video receiver 1 is turned on and the index image is displayed on the TV monitor 2.

If the conditions for displaying the index image are set in accordance with the operation menu shown in FIG. 9B, the operation menu for turning on or off “automatic multi-screen setting” is displayed based on the input conditions as shown in FIG. 9C.

FIG. 9C illustrates an example of turning on the “automatic multi screen setting”. When the “automatic multi screen setting” is turned on and the video receiver 1 is turned on, the index image is displayed based on the conditions set on the menu shown in FIG. 9B.

An example of the operation of the video receiver 1 for displaying the external recording medium thumbnail index image will be described with reference to FIG. 10. FIG. 10 is a flowchart, which shows procedures for the operation of the video receiver 1 for displaying the external recording medium thumbnail index image.

When the video receiver 1 is turned on (in a step S11), it is determined whether the automatic multi screen setting is made (in a step S12). If the automatic multi screen setting is not made (“NO” in the step S12), the video receiver is normally turned on (in a step S13).

The operation remote controller 3 is provided with the specific display-dedicated key. If the video receiver is turned on by the operation of this specific display-dedicated key (in the step S11), the operation of the specific display-dedicated key is invalidated in the step S13.

If the automatic multi screen setting is made (“YES” in the step S12), the HDD recording and reproducing apparatus 30 externally connected to the video receiver 1 is requested to transmit the external recording medium thumbnail index image (in a step S14).

If a reply from the HDD recording and reproducing apparatus 30 to the transmission request made in the step S14 is not detected (“NO” in a step S15), and a reply to up to three transmission requests is not detected, then it is determined that an apparatus externally connected to the video receiver 1 is not present, and the reading of the external recording medium thumbnail index image is stopped (in a step S16).

If the reply from the HDD recording and reproducing apparatus 30 is detected (“YES” in the step S15), data on the external recording medium thumbnail index image is read from the HDD recording and reproducing apparatus 30 (in a step S17).

Next, the external recording medium thumbnail index image read in the step S17 is stored in the external memory 17 or the recording medium 23 of the video receiver 1 (in a step S18). The external recording medium thumbnail index image is displayed on the TV monitor 2 in accordance with the set contents set by the “display selection” item on the operation menu (in a step S19).

In the procedures described above, the example of transmitting the external recording medium thumbnail index image from the HDD recording and reproducing apparatus 30 to the video receiver 1, and displaying this external recording medium thumbnail index image on the TV monitor 2 has been described (in the steps S14 to S19).

Alternatively, the video receiver 1 described so far can be constituted and caused to operate as follows for displaying the external recording medium thumbnail index image on the TV monitor 2. A thumbnail forming means for forming the thumbnail index image is provided in the video receiver 1.

The video receiver 1 requests the HDD recording and reproducing apparatus 30 to transmit recorded files. In the video receiver 1, the thumbnail forming means forms the external recording medium thumbnail index image based on the transmitted-recorded files. The external recording medium thumbnail index image thus formed is displayed on the TV monitor 2.

Further, the video receiver 1 described so far can be constituted and caused to operate as follows. An HDD recording and reproducing means (hereinafter, “internal HDD recording and reproducing means”) besides the DVD recording and reproducing means 20 is provided in the main body la of the video receiver 1.

The index image displayed on the TV monitor 2 when the video receiver 1 is turned on is constituted as shown in FIG. 11. FIG. 11 illustrates one example of the index image displayed on the TV monitor 2 by the screen division display.

In the example shown in FIG. 11, a recording medium thumbnail index image 61 is displayed in the first region 2a of the TV monitor 2, and a recording medium thumbnail index image 62 is displayed in the second region 2b thereof.

The recording medium thumbnail index image 61 is a thumbnail index image, which shows indexes of the recorded files recorded in a hard disk (HD) of the internal HDD recording and reproducing means.

The recording medium thumbnail index image 62 is a thumbnail index image, which shows indexes of the recorded files recorded in the DVD disk 23 of the DVD recording and reproducing means 20.

By selecting a specific frame in this recording medium thumbnail index image 61, the video receiver 1 is caused to operate so that the DVD recording and reproducing means 20 performs so-called dubbing for the recorded file corresponding to the selected frame.

For example, if an operation for selecting and defining an upper most frame on a right end of the recording medium thumbnail index image 61 is to be performed, the video receiver 1 is caused to operate so that the DVD recording and reproducing means 20 records a recorded file corresponding to this frame to the DVD disk 23.

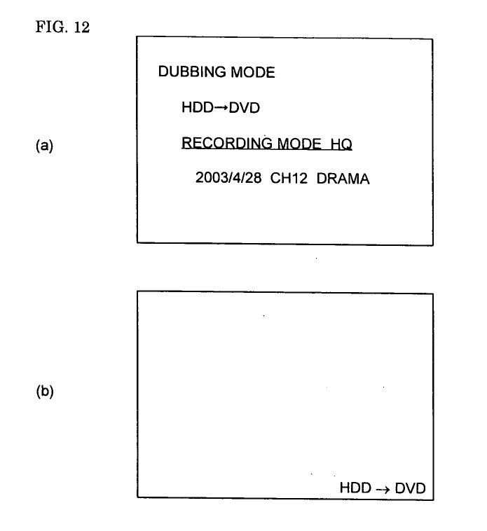

FIGS. 12A and 12B illustrate examples of the display of the screen in a dubbing mode for performing dubbing based on the recording medium thumbnail index image 61. FIG. 12A illustrates the display of the TV monitor 2 for checking dubbing conditions. FIG. 12B illustrates the display of the TV monitor 2 after the dubbing is started.

When the operation for selecting and defining one of the frames in the recording medium thumbnail index image 61 shown in FIG. 11 is performed, the dubbing condition is displayed on the TV monitor as shown in FIG. 12A.

When the operation for starting the dubbing is performed (e.g., operation of ENTER key is performed), then the display of the TV monitor 2 is changed as shown in FIG. 12B, the dubbing is started, and the recorded file reproduced by the internal HDD recording and reproducing means is recorded by the DVD recording and reproducing means 20.

The examples of employing the DVD recording and reproducing means 20 and the HDD recording and reproducing apparatus 30 as the recording and reproducing means have been described. However, arbitrary recording and reproducing means can be employed in working the video receiver or the video receiving system according to the present invention as long as the recording and reproducing means can reproduce the video and the voice recorded in the recording medium, and can record the video and the voice in the recording medium. For example, a VTR can be employed as the recording and reproducing means.

The examples of employing the recording and reproducing means have been described so far. In working the present invention, a reproducing means, which does not include a recording means can be employed.

That is, in working the video receiver according to the present invention, the recording medium thumbnail index image recorded in the recording medium can be displayed on the TV monitor even if the recording means cannot used as long as the reproducing means is usable.

As stated so far, according to the present invention, the recording medium thumbnail index image and the broadcast channel index image can be displayed on the TV monitor when the video receiver is turned on. This can there by facilitate easy checking the broadcast channels, which can be viewed and listened to, and the recorded files recorded in the recording medium.

In addition, a specific recorded file or broadcast channel can be selected and viewed and listened to based on the displayed recording medium thumbnail index image or the broadcast channel index image.

1. A video receiver comprising a television monitor for receiving one of broadcast channels transmitted from a broadcast station, and for outputting a broadcast content on the received broadcast channel, wherein
reproducing means, connected to the video receiver, for reproducing each of recorded contents in a recording medium is controlled to output the recorded content reproduced by the reproducing means to said television monitor,
a recording medium thumbnail index image which shows indexes of the recorded contents in the recording medium is recorded in said recording medium,
the video receiver comprises a control section which controls an operation of the video receiver, and
when the video receiver is turned on, said control section controls said reproducing means to read said recording medium thumbnail index image from said recording medium, and to output the recording medium thumbnail index image to said television monitor.

2. The video receiver according to claim 1, further comprising:
a broadcast channel index image storage section which stores a broadcast channel index image showing indexes of the broadcast channels which can be received by the video receiver, wherein
the broadcast channels to be received are sequentially set to a tuner for receiving the broadcast channels, one image in the broadcast content on each of the received broadcast channels is sequentially stored for the each received broadcast channel in said broadcast channel index image storage section, and said broadcast channel index image is formed,
the video receiver further comprises an image forming section which forms an image to be output to said television monitor,
said image forming section forms a compound index image from said recording medium thumbnail index image and said broadcast channel index image, and
when the video receiver is turned on, said compound index image is output to said television monitor.

3. The video receiver according to claim 2, further comprising:
a screen dividing section which performs a processing for dividing the image to be displayed entirely on one screen of the television monitor into a plurality of parts, and for displaying the divided parts on said one screen of the television monitor, wherein
said screen dividing section divides said compound index image into said recording medium thumbnail index image and said broadcast channel index image, and
said recording medium thumbnail index image is displayed in a first region on the one screen of said television monitor, and said broadcast channel index image is displayed in a second region on the one screen of said television monitor.

4. The video receiver according to claim 1, wherein
a plurality of said recording means are connected, and the recording medium thumbnail index image is recorded in each recording medium to be reproduced by each of said reproducing means,
the video receiver further comprises an image forming section which forms an image to be output to the television monitor,
a plurality of said recording medium thumbnail index images are read from the plurality of said recording mediums, respectively, and the image forming section combines the read plurality of recording medium thumbnail index images into a recording medium combined index image composed of one image, and
when the video receiver is turned on, said recording medium combined index image is displayed on the television monitor.

5. The video receiver according to any one of claims 1 to 4 claim 1 wherein
reproducing means disposed in a main body of the video receiver is provided as said reproducing means.

6. The video receiver according to claim 1, wherein
a reproducing apparatus disposed as an external apparatus other than the video receiver is connected to the video receiver as said reproducing means.

7. A video receiving system comprising:
the video receiver comprising a television monitor for receiving one of broadcast channels transmitted from a broadcast station, and for outputting a broadcast content on the received broadcast channel, wherein reproducing means, connected to the video receiver, for reproducing each of recorded contents in a recording medium is controlled to output the recorded content reproduced by the reproducing means to said television monitor, a recording medium thumbnail index image which shows indexes of the recorded contents in the recording medium is recorded in said recording medium, the video receiver comprises a control section which controls an operation of the video receiver, and when the video receiver is turned on, said control section controls said reproducing means to read said recording medium thumbnail index image from said recording medium, and to output the recording medium thumbnail index image to said television monitor and further comprising a broadcast channel index image storage section which stores a broadcast channel index image showing indexes of the broadcast channels which can be received by the video receiver, wherein the broadcast channels to be received are sequentially set to a tuner for receiving the broadcast channels, one image in the broadcast content on each of the received broadcast channels is sequentially stored for the each received broadcast channel in said broadcast channel index image storage section, and said broadcast channel index image is formed, the video receiver further comprises an image forming section which forms an image to be output to said television monitor, said image forming section forms a compound index image from said recording medium thumbnail index image and said broadcast channel index image, and when the video receiver is turned on, said compound index image is output to said television monitor further comprising a screen dividing section which performs a processing for dividing the image to be displayed entirely on one screen of the television monitor into a plurality of parts, and for displaying the divided parts on said one screen of the television monitor, wherein said screen dividing section divides said compound index image into said recording medium thumbnail index image and said broadcast channel index image, and said recording medium thumbnail index image is displayed in a first region on the one screen of said television monitor, and said broadcast channel index image is displayed in a second region on the one screen of said television monitor wherein a plurality of said recording means are connected, and the recording medium thumbnail index image is recorded in each recording medium to be reproduced by each of said reproducing means, the video receiver further comprises an image forming section which forms an image to be output to the television monitor, a plurality of said recording medium thumbnail index images are read from the plurality of said recording mediums, respectively, and the image forming section combines the read plurality of recording medium thumbnail index images into a recording medium combined index image composed of one image, and when the video receiver is turned on, said recording medium combined index image is displayed on the television monitor, wherein reproducing means disposed in a main body of the video receiver is provided as said reproducing means, wherein a reproducing apparatus disposed as an external apparatus other than the video receiver is connected to the video receiver as said reproducing means, and
said reproducing apparatus disposed as the external apparatus other than the video receiver.

8. The video receiver according to claim 2, wherein
reproducing means disposed in a main body of the video receiver is provided as said reproducing means.

9. The video receiver according to claim 3, wherein
reproducing means disposed in a main body of the video receiver is provided as said reproducing means.

10. The video receiver according to claim 4, wherein
reproducing means disposed in a main body of the video receiver is provided as said reproducing means.

11. The video receiver according to claim 2, wherein
a reproducing apparatus disposed as an external apparatus other than the video receiver is connected to the video receiver as said reproducing means.

12. The video receiver according to claim 3, wherein
a reproducing apparatus disposed as an external apparatus other than the video receiver is connected to the video receiver as said reproducing means.

13. The video receiver according to claim 4, wherein
a reproducing apparatus disposed as an external apparatus other than the video receiver is connected to the video receiver as said reproducing means.

14. The video receiver according to claim 5, wherein
a reproducing apparatus disposed as an external apparatus other than the video receiver is connected to the video receiver as said reproducing means.

15. The video receiver according to claim, 8, wherein
a reproducing apparatus disposed as an external apparatus other than the video receiver is connected to the video receiver as said reproducing means.

16. The video receiver according to claim 9, wherein
a reproducing apparatus disposed as an external apparatus other than the video receiver is connected to the video receiver as said reproducing means.

17. The video receiver according to claim 10, wherein
a reproducing apparatus disposed as an external apparatus other than the video receiver is connected to the video receiver as said reproducing means.
